(19) United States
(12) Patent Application Publication
(10) Pub. No.: US 2024/0426171 A1
(43) Pub. Date: Dec. 26, 2024

(54) GUARD FOR A DOOR AND DOORFRAME

(71) Applicant: MWR Holdings, LLC, Deerfield Beach, FL (US)

(72) Inventor: David Slavny, Deerfield Beach, FL (US)

(21) Appl. No.: 18/213,333

(22) Filed: Jun. 23, 2023

(51) Int. Cl. E06B 7/36

(52) U.S. Cl. CPC E06B 7/367

(57) ABSTRACT

A system, including: a doorframe, having: first and second side jambs, and a head jamb; a door; a door hinge that connects the first side jamb to the door; a guard, including: a plurality of body portions, including a first body portion, a second body portion, a third body portion, a fourth body portion, a fifth body portion, and a sixth body portion, where the first body portion connects to the second body portion, where the second body portion connects to the third body portion, where the third body portion connects to the fourth body portion, where the fourth body portion connects to the fifth body portion, and where the fifth body portion connects to the sixth body portion; and a plurality of magnetic strips, including a first magnetic strip and a second magnetic strip, where the first magnetic strip and the second magnetic strip are magnets, where the first magnetic strip is adhered to the first body portion and extends between top and bottom ends of the first body portion, where the second magnetic strip is adhered to the sixth body portion and extends between top and bottom ends of the sixth body portion, where the first magnetic strip is magnetically coupled to the door, and where the second magnetic strip is magnetically coupled to the first side jamb.

### FIELD

The present invention relates to a guard for a door and doorframe, and, more particularly, to a guard configured to prevent insertion of a part of a body in a gap between the door and a side jamb of the doorframe.

### BACKGROUND

Generally, hinges connect a door connects to a side jamb of a doorframe. There is the risk that person, such as a child, may insert their finger or another part of their body into a gap between the side jamb of the doorframe and the door. Closing the door when the finger or other part of the body is in the gap may cause a serious injury.

### SUMMARY

The Claims, rather than the Summary, define covered embodiments of the present invention. The Summary is a high-level overview of various aspects of the invention, and introduces some concepts that are further described in the Detailed Description below. The Summary is not intended to identify key or essential features of the claimed subject matter, and also is not intended to be used in isolation to determine the scope of the claimed subject matter. Instead, the claimed subject matter should be understood by reference to appropriate portions of the Specification and drawings, as well as to each claim.

In some embodiments, the present invention provides a system, comprising: a doorframe, comprising: a first side jamb, having a top end and a bottom end, a second side jamb, having a top end and a bottom end, and a head jamb, extending between the top end of the first side jamb and the top end of the second side jamb, wherein the first side jamb comprises a magnetic material; a door, comprising: a first side, having a top end and a bottom end, a second side, having a top end and a bottom end, a bottom side, extending between the bottom end of the first side and the bottom end of the second side, and a top side, extending between the top end of the first side and the top end of the second side, wherein the door comprises a magnetic material; a door hinge that connects the first side jamb of the doorframe to the first side of the door; a guard, comprising: a plurality of body portions, wherein each of the body portions comprises a top end and a bottom end, wherein the plurality of body portions comprises a first body portion, a second body portion, a third body portion, a fourth body portion, a fifth body portion, and a sixth body portion, wherein the first body portion connects to the second body portion, wherein the second body portion connects to the third body portion, wherein the third body portion connects to the fourth body portion, wherein the fourth body portion connects to the fifth body portion, and wherein the fifth body portion connects to the sixth body portion; and a plurality of magnetic strips, wherein the plurality of magnetic strips comprises a first magnetic strip and a second magnetic strip, wherein the first magnetic strip and the second magnetic strip are magnets, wherein the first magnetic strip is adhered to the first body portion and extends between the top end of the first body portion and the bottom end of the first body portion, wherein the second magnetic strip is adhered to the sixth body portion and extends between the top end of the sixth body portion and the bottom end of the sixth body portion, wherein the first magnetic strip is magnetically coupled to the door, and wherein the second magnetic strip is magnetically coupled to the first side jamb.

In some embodiments, the guard further comprises: a plurality of connecting portions, wherein the plurality of connecting portions comprises a first connecting portion, a second connecting portion, a third connecting portion, a fourth connecting portion, and a fifth connecting portion, wherein the first connecting portion connects the first body portion and the second body portion, wherein the second connecting portion connects the second body portion and the third body portion, wherein the third connecting portion connects the third body portion and the fourth body portion, wherein the fourth connecting portion connects the fourth body portion and the fifth body portion, and wherein the fifth connecting portion connects the fifth body portion and the sixth body portion.

In some embodiments, the guard comprises polymer.

In some embodiments, the first magnetic strip extends from the top end of the first body portion to the bottom end of the first body portion.

In some embodiments, the second magnetic strip extends from the top end of the sixth body portion to the bottom end of the sixth body portion.

In some embodiments, the second body portion, the third body portion, the fourth body portion, and the fifth body portion form an M shape.

In some embodiments, the second connecting portion hingedly connects the second body portion and the third body portion, the third connecting portion hingedly connects the third body portion and the fourth body portion, and the fourth connecting portion hingedly connects the fourth body portion and the fifth body portion.

In some embodiments, the door hinge comprises a first hinge leaf, a second hinge leaf, a first hinge knuckle connected to the first hinge leaf, a second hinge knuckle connected to the second hinge leaf, and a hinge pin connecting the first hinge knuckle and the second hinge knuckle, wherein the door comprises a first face and a second face opposite the first face, wherein the first hinge knuckle is proximate the first face of the door, and wherein the first magnetic strip is magnetically coupled to the first face of the door, such that the guard covers the first hinge knuckle.

In some embodiments, the door hinge comprises a first hinge leaf, a second hinge leaf, a first hinge knuckle connected to the first hinge leaf, a second hinge knuckle connected to the second hinge leaf, and a hinge pin connecting the first hinge knuckle and the second hinge knuckle, wherein the door comprises a first face and a second face opposite the first face, wherein the first hinge knuckle is proximate the first face of the door, and wherein the first magnetic strip is magnetically coupled to the second face of the door.

In some embodiments, a length of the first body portion is at least 50% of a length of the first side of the door.

In some embodiments, a length of the first magnetic strip is at least 50% of a length of the first body portion.

In some embodiments, the present invention provides a guard, comprising: a plurality of body portions, wherein each of the body portions comprises a top end and a bottom end, wherein the plurality of body portions comprises a first body portion, a second body portion, a third body portion, a fourth body portion, a fifth body portion, and a sixth body portion, wherein the first body portion connects to the second body portion, wherein the second body portion connects to the third body portion, wherein the third body portion connects to the fourth body portion, wherein the fourth body portion connects to the fifth body portion, and wherein the fifth body portion connects to the sixth body portion; and a plurality of magnetic strips, wherein the plurality of magnetic strips comprises a first magnetic strip and a second magnetic strip, wherein the first magnetic strip and the second magnetic strip are magnets, wherein the first magnetic strip is adhered to the first body portion and between the top end of the first body portion and the bottom end of the first body portion, wherein the second magnetic strip is adhered to the sixth body portion and between the top end of the sixth body portion and the bottom end of the sixth body portion, wherein the first magnetic strip is configured to magnetically couple to a door framed by a doorframe, and wherein the second magnetic strip is configured to magnetically couple to the doorframe.

In some embodiments, the guard further comprises: a plurality of connecting portions, wherein the plurality of connecting portions comprises a first connecting portion, a second connecting portion, a third connecting portion, a fourth connecting portion, and a fifth connecting portion, wherein the first connecting portion connects the first body portion and the second body portion, wherein the second connecting portion connects the second body portion and the third body portion, wherein the third connecting portion connects the third body portion and the fourth body portion, wherein the fourth connecting portion connects the fourth body portion and the fifth body portion, and wherein the fifth connecting portion connects the fifth body portion and the sixth body portion.

In some embodiments, the plurality of connecting portions comprises polymer.

In some embodiments, the first magnetic strip extends from the top end of the first body portion to the bottom end of the first body portion.

In some embodiments, the second magnetic strip extends from the top end of the sixth body portion to the bottom end of the sixth body portion.

In some embodiments, a length of the first magnetic strip is at least 50% of a length of the first body portion.

In some embodiments, the second connecting portion hingedly connects the second body portion and the third body portion, the third connecting portion hingedly connects the third body portion and the fourth body portion, and the fourth connecting portion hingedly connects the fourth body portion and the fifth body portion.

In some embodiments, the guard further comprises: a first adhesive that adheres the first magnetic strip to the first body portion, and a second adhesive that adheres the second magnetic strip to the sixth body portion.

In some embodiments, a length of the first magnetic strip is at least 50% of a length of the first body portion.

### BRIEF DESCRIPTION OF THE FIGURES

This section refers to the drawings that form a part of this disclosure, and which illustrate some of the embodiments of structure, materials, and/or methods of the present invention described herein.

FIG. 1 is a front view of a doorframe framing a door, and onto which a guard may be installed, according to some embodiments.

FIG. 2 is a detail view of a door hinge connecting the door to the doorframe, from FIG. 1, according to some embodiments.

FIG. 3 is a schematic top view of the guard configured to be installed on the door and the doorframe, according to some embodiments.

FIG. 4 is a front view of the guard of FIG. 3, according to some embodiments.

FIG. 5 is a detail view of the guard, from FIG. 4, according to some embodiments.

FIG. 6 is a top view of the guard installed on the doorframe and the door and the door is closed, according to some embodiments of the invention.

FIG. 7 is a top view of the guard installed on the doorframe and the door and the door is open, according to some embodiments of the invention.

### DETAILED DESCRIPTION

In addition to the benefits and improvements that the Specification discloses, other objects and advantages that the Specification provides will become apparent from the following description taken in conjunction with the accompanying figures. Although the description discloses and describes detailed embodiments of the present disclosure, the disclosed embodiments are merely illustrative of the disclosure that may be embodied in various forms. In addition, each of the examples given regarding the various embodiments of the disclosure is intended to be illustrative, and not restrictive.

In some embodiments, the present invention provides a guard configured to prevent a child or other person from inserting their finger or another part of their body into a gap between a doorframe and a door.

In some embodiments, the guard comprises a plurality of body portions that are connected to one another. In some embodiments, each of the body portions comprises a top end and a bottom end. In some embodiments, the plurality of body portions comprises a first body portion, a second body portion, a third body portion, a fourth body portion, a fifth body portion, and a sixth body portion. In some embodiments, the first body portion connects to the second body portion. In some embodiments, the second body portion connects to the third body portion. In some embodiments, the third body portion connects to the fourth body portion. In some embodiments, the fourth body portion connects to the fifth body portion. In some embodiments, the fifth body portion connects to the sixth body portion.

In some embodiments, the guard comprises a plurality of magnetic strips. In some embodiments, the plurality of magnetic strips comprises a first magnetic strip and a second magnetic strip. In some embodiments, either or both of the first magnetic strip and/or the second magnetic strip are magnets—that is, they are attracted to certain metals. In some embodiments, the first magnetic strip is adhered to the first body portion. In some embodiments, the second magnetic strip is adhered to the sixth body portion. In some embodiments, the first magnetic strip is configured to be magnetically coupled to a magnetic side jamb of a doorframe, and the second magnetic strip is configured to be magnetically coupled to a magnetic door. In some embodiments, the first magnetic strip is configured to be magnetically coupled to the magnetic door, and the second magnetic strip is configured to be magnetically coupled to the magnetic side jamb of the doorframe.

In some embodiments, a surface or surfaces on which the magnetic strip or strips are adhered is a smooth surface.

In some embodiments, the plurality of body portions are hingedly connected to one another. In some embodiments, the plurality of body portions are hingedly connected to one another by a plurality of connecting portions. In some embodiments, the plurality of connecting portions comprises a first connecting portion, a second connecting portion, a third connecting portion, a fourth connecting portion, and a fifth connecting portion. In some embodiments, the first connecting portion connects the first body portion and the second body portion. In some embodiments, the second connecting portion connects the second body portion and the third body portion. In some embodiments, the third connecting portion connects the third body portion and the fourth body portion. In some embodiments, the fourth connecting portion connects the fourth body portion and the fifth body portion. In some embodiments, the fifth connecting portion connects the fifth body portion and the sixth body portion.

In some embodiments, the guard comprises polymer. In some embodiments, one or more portions of the guard comprises vinyl. In some embodiments, one or more portions of the guard comprise polyvinylchloride (PVC). In some embodiments, one or more portions of the guard comprise clear PVC. In some embodiments, the material has one or more, or all, of the following characteristics: specific gravity of 1.20, when tested in accordance with ASTM D 792; durometer A value, 10 second (⅛″/24 hr) of 75, when tested in accordance with ASTM D 2240; tensile strength (75 mil) of 1700 psi, when tested in accordance with ASTM D 638; elongation (75 mil) of 390%, when tested in accordance with ASTM D 638; and/or modulus 100% (75 mil) of 1100 psi, when tested in accordance with ASTM D 638. In some embodiments, the material has one or more, or all, of the following characteristics: specific gravity of 1.32; Izod impact (0.125″ test specimen), 16.0 ft-lbs./in notch, when tested in accordance with ASTM D 256; tensile yield strength (0.125″ test specimen), 6.4×10³ psi, when tested in accordance with ASTM D 638; tensile modulus (0.125″ test specimen), 3.6×10⁵ psi, when tested in accordance with ASTM D 638; flexural yield strength (0.125″ test specimen), 12.0×10³ psi, when tested in accordance with ASTM D 790; flexural modulus (0.125″ test specimen), 4.0×10⁵ psi, when tested in accordance with ASTM D 790; and/or DTUL at 265 psi (0.125″ test specimen), 67 C°, when tested in accordance with ASTM D 648.

In some embodiments, the first magnetic strip extends between the top end of the first body portion and the bottom end of the first body portion. In some embodiments, the first magnetic strip extends from the top end of the first body portion and the bottom end of the first body portion. In some embodiments, the second magnetic strip extends between the top end of the sixth body portion to the bottom end of the sixth body portion. In some embodiments, the second magnetic strip extends from the top end of the sixth body portion to the bottom end of the sixth body portion.

In some embodiments, the first body portion and/or the sixth body portion are approximately one-half inch in width.

In some embodiments, the guard comprises an M shape. In some embodiments, the second body portion, the third body portion, the fourth body portion, and the fifth body portion form an M shape. In some embodiments, the second body portion, the second connecting portion, the third body portion, the third connecting portion, the fourth body portion, the fourth connecting portion, and the fifth body portion form an M shape. In some embodiments, the guard comprises an M shape when uninstalled. In some embodiments, the guard comprises an M shape when installed and the door is opened.

In some embodiments, the present invention provides a system comprising a doorframe including a first side jamb having a top end and a bottom end, a second side jamb having a top end and a bottom end, and a head jamb extending between the top end of the first side jamb and the top end of the second side jamb. In some embodiments, the first side jamb to which the guard is to be magnetically coupled comprises a magnetic material—that is, a metal material attracted to a magnet.

In some embodiments, the system further comprise a door including a first side having a top end and a bottom end, a second side having a top end and a bottom end, a bottom side extending between the bottom end of the first side and the bottom end of the second side, and a top side extending between the top end of the first side and the top end of the second side. In some embodiments, a component of the door to which the guard is to be magnetically coupled comprises a magnetic material—that is, a metal material attracted to a magnet.

In some embodiments, the system further comprises at least one door hinge that connects a side jamb of the doorframe to a side of the door. In some embodiments, the system comprises more than one door hinge. In some embodiments, the system comprise two, three, four, five, six, or more than six door hinges. In some embodiments, the system includes the guard. In some embodiments, the guard is on a door-hinge side of the door. In some embodiments, the guard is on a non-door-hinge side of the door.

In some embodiments, one or more, or all, of the door hinges comprise a first hinge leaf, a second hinge leaf, a first hinge knuckle connected to the first hinge leaf, a second hinge knuckle connected to the second hinge leaf, and a hinge pin connecting the first hinge knuckle and the second hinge knuckle. In some embodiments, the door comprises a first face and a second face opposite the first face, where the first hinge knuckle and/or the second hinge knuckle is proximate the first face of the door. In some embodiments, the second magnetic strip is magnetically coupled to the first face of the door, such that the guard covers the first hinge knuckle and/or the second hinge knuckle. Thus, in some embodiments, the guard is on the door-hinge side of the door and doorframe. In some embodiments, the second magnetic strip is magnetically coupled to the second face of the door. Thus, in some embodiments, the guard is on the non-door-hinge side of the door and doorframe. In some embodiments, the system comprises at least two guards—one on each side of the door and doorframe.

In some embodiments, a length of the first body portion is at least 50% of a length of the first side of the door. In some embodiments, the length of the first body portion is at least 55% of the length of the first side of the door. In some embodiments, the length of the first body portion is at least 60% of the length of the first side of the door. In some embodiments, the length of the first body portion is at least 70% of the length of the first side of the door. In some embodiments, the length of the first body portion is at least 55% of the length of the first side of the door. In some embodiments, the length of the first body portion is at least 75% of the length of the first side of the door. In some embodiments, the length of the first body portion is at least 80% of the length of the first side of the door. In some embodiments, the length of the first body portion is at least 85% of the length of the first side of the door. In some embodiments, the length of the first body portion is at least 90% of the length of the first side of the door. In some embodiments, the length of the first body portion is at least 95% of the length of the first side of the door. In some embodiments, the length of the first body portion is at least 96% of the length of the first side of the door. In some embodiments, the length of the first body portion is at least 97% of the length of the first side of the door. In some embodiments, the length of the first body portion is at least 98% of the length of the first side of the door. In some embodiments, the length of the first body portion is at least 99% of the length of the first side of the door.

In some embodiments, the length of the first body portion is 50% to 99% of the length of the first side of the door. In some embodiments, the length of the first body portion is 50% to 98% of the length of the first side of the door. In some embodiments, the length of the first body portion is 50% to 97% of the length of the first side of the door. In some embodiments, the length of the first body portion is 50% to 96% of the length of the first side of the door. In some embodiments, the length of the first body portion is 50% to 95% of the length of the first side of the door. In some embodiments, the length of the first body portion is 50% to 90% of the length of the first side of the door. In some embodiments, the length of the first body portion is 50% to 85% of the length of the first side of the door. In some embodiments, the length of the first body portion is 50% to 80% of the length of the first side of the door. In some embodiments, the length of the first body portion is 50% to 75% of the length of the first side of the door. In some embodiments, the length of the first body portion is 50% to 70% of the length of the first side of the door. In some embodiments, the length of the first body portion is 50% to 65% of the length of the first side of the door. In some embodiments, the length of the first body portion is 50% to 60% of the length of the first side of the door. In some embodiments, the length of the first body portion is 50% to 55% of the length of the first side of the door.

In some embodiments, the length of the first body portion is 55% to 99% of the length of the first side of the door. In some embodiments, the length of the first body portion is 55% to 98% of the length of the first side of the door. In some embodiments, the length of the first body portion is 55% to 97% of the length of the first side of the door. In some embodiments, the length of the first body portion is 55% to 96% of the length of the first side of the door. In some embodiments, the length of the first body portion is 55% to 95% of the length of the first side of the door. In some embodiments, the length of the first body portion is 55% to 90% of the length of the first side of the door. In some embodiments, the length of the first body portion is 55% to 85% of the length of the first side of the door. In some embodiments, the length of the first body portion is 55% to 80% of the length of the first side of the door. In some embodiments, the length of the first body portion is 55% to 75% of the length of the first side of the door. In some embodiments, the length of the first body portion is 55% to 70% of the length of the first side of the door. In some embodiments, the length of the first body portion is 55% to 65% of the length of the first side of the door. In some embodiments, the length of the first body portion is 55% to 60% of the length of the first side of the door.

In some embodiments, the length of the first body portion is 60% to 99% of the length of the first side of the door. In some embodiments, the length of the first body portion is 60% to 98% of the length of the first side of the door. In some embodiments, the length of the first body portion is 60% to 97% of the length of the first side of the door. In some embodiments, the length of the first body portion is 60% to 96% of the length of the first side of the door. In some embodiments, the length of the first body portion is 60% to 95% of the length of the first side of the door. In some embodiments, the length of the first body portion is 60% to 90% of the length of the first side of the door. In some embodiments, the length of the first body portion is 60% to 85% of the length of the first side of the door. In some embodiments, the length of the first body portion is 60% to 80% of the length of the first side of the door. In some embodiments, the length of the first body portion is 60% to 75% of the length of the first side of the door. In some embodiments, the length of the first body portion is 60% to 70% of the length of the first side of the door. In some embodiments, the length of the first body portion is 60% to 65% of the length of the first side of the door.

In some embodiments, the length of the first body portion is 65% to 99% of the length of the first side of the door. In some embodiments, the length of the first body portion is 65% to 98% of the length of the first side of the door. In some embodiments, the length of the first body portion is 65% to 97% of the length of the first side of the door. In some embodiments, the length of the first body portion is 65% to 96% of the length of the first side of the door. In some embodiments, the length of the first body portion is 65% to 95% of the length of the first side of the door. In some embodiments, the length of the first body portion is 65% to 90% of the length of the first side of the door. In some embodiments, the length of the first body portion is 65% to 85% of the length of the first side of the door. In some embodiments, the length of the first body portion is 65% to 80% of the length of the first side of the door. In some embodiments, the length of the first body portion is 65% to 75% of the length of the first side of the door. In some embodiments, the length of the first body portion is 65% to 70% of the length of the first side of the door.

In some embodiments, the length of the first body portion is 70% to 99% of the length of the first side of the door. In some embodiments, the length of the first body portion is 70% to 98% of the length of the first side of the door. In some embodiments, the length of the first body portion is 70% to 97% of the length of the first side of the door. In some embodiments, the length of the first body portion is 70% to 96% of the length of the first side of the door. In some embodiments, the length of the first body portion is 70% to 95% of the length of the first side of the door. In some embodiments, the length of the first body portion is 70% to 90% of the length of the first side of the door. In some embodiments, the length of the first body portion is 70% to 85% of the length of the first side of the door. In some embodiments, the length of the first body portion is 70% to 80% of the length of the first side of the door. In some embodiments, the length of the first body portion is 70% to 75% of the length of the first side of the door.

In some embodiments, the length of the first body portion is 75% to 99% of the length of the first side of the door. In some embodiments, the length of the first body portion is 75% to 98% of the length of the first side of the door. In some embodiments, the length of the first body portion is 75% to 97% of the length of the first side of the door. In some embodiments, the length of the first body portion is 75% to 96% of the length of the first side of the door. In some embodiments, the length of the first body portion is 75% to 95% of the length of the first side of the door. In some embodiments, the length of the first body portion is 75% to 90% of the length of the first side of the door. In some embodiments, the length of the first body portion is 75% to 85% of the length of the first side of the door. In some embodiments, the length of the first body portion is 75% to 80% of the length of the first side of the door.

In some embodiments, the length of the first body portion is 80% to 99% of the length of the first side of the door. In some embodiments, the length of the first body portion is 80% to 98% of the length of the first side of the door. In some embodiments, the length of the first body portion is 80% to 97% of the length of the first side of the door. In some embodiments, the length of the first body portion is 80% to 96% of the length of the first side of the door. In some embodiments, the length of the first body portion is 80% to 95% of the length of the first side of the door. In some embodiments, the length of the first body portion is 80% to 90% of the length of the first side of the door. In some embodiments, the length of the first body portion is 80% to 85% of the length of the first side of the door.

In some embodiments, the length of the first body portion is 85% to 99% of the length of the first side of the door. In some embodiments, the length of the first body portion is 85% to 98% of the length of the first side of the door. In some embodiments, the length of the first body portion is 85% to 97% of the length of the first side of the door. In some embodiments, the length of the first body portion is 85% to 96% of the length of the first side of the door. In some embodiments, the length of the first body portion is 85% to 95% of the length of the first side of the door. In some embodiments, the length of the first body portion is 85% to 90% of the length of the first side of the door.

In some embodiments, the length of the first body portion is 90% to 99% of the length of the first side of the door. In some embodiments, the length of the first body portion is 90% to 98% of the length of the first side of the door. In some embodiments, the length of the first body portion is 90% to 97% of the length of the first side of the door. In some embodiments, the length of the first body portion is 90% to 96% of the length of the first side of the door. In some embodiments, the length of the first body portion is 90% to 95% of the length of the first side of the door.

In some embodiments, the length of the first body portion is 95% to 99% of the length of the first side of the door. In some embodiments, the length of the first body portion is 95% to 98% of the length of the first side of the door. In some embodiments, the length of the first body portion is 95% to 97% of the length of the first side of the door. In some embodiments, the length of the first body portion is 95% to 96% of the length of the first side of the door.

In some embodiments, the length of the first body portion is 96% to 99% of the length of the first side of the door. In some embodiments, the length of the first body portion is 96% to 98% of the length of the first side of the door. In some embodiments, the length of the first body portion is 96% to 97% of the length of the first side of the door.

In some embodiments, the length of the first body portion is 97% to 99% of the length of the first side of the door. In some embodiments, the length of the first body portion is 97% to 98% of the length of the first side of the door. In some embodiments, the length of the first body portion is 97% to 98% of the length of the first side of the door.

In some embodiments, a length of the sixth body portion is at least 50% of a length of the first side of the door. In some embodiments, the length of the sixth body portion is at least 55% of the length of the first side of the door. In some embodiments, the length of the sixth body portion is at least 60% of the length of the first side of the door. In some embodiments, the length of the sixth body portion is at least 70% of the length of the first side of the door. In some embodiments, the length of the sixth body portion is at least 55% of the length of the first side of the door. In some embodiments, the length of the sixth body portion is at least 75% of the length of the first side of the door. In some embodiments, the length of the sixth body portion is at least 80% of the length of the first side of the door. In some embodiments, the length of the sixth body portion is at least 85% of the length of the first side of the door. In some embodiments, the length of the sixth body portion is at least 90% of the length of the first side of the door. In some embodiments, the length of the sixth body portion is at least 95% of the length of the first side of the door. In some embodiments, the length of the sixth body portion is at least 96% of the length of the first side of the door. In some embodiments, the length of the sixth body portion is at least 97% of the length of the first side of the door. In some embodiments, the length of the sixth body portion is at least 98% of the length of the first side of the door. In some embodiments, the length of the sixth body portion is at least 99% of the length of the first side of the door.

In some embodiments, the length of the sixth body portion is 50% to 99% of the length of the first side of the door. In some embodiments, the length of the sixth body portion is 50% to 98% of the length of the first side of the door. In some embodiments, the length of the sixth body portion is 50% to 97% of the length of the first side of the door. In some embodiments, the length of the sixth body portion is 50% to 96% of the length of the first side of the door. In some embodiments, the length of the sixth body portion is 50% to 95% of the length of the first side of the door. In some embodiments, the length of the sixth body portion is 50% to 90% of the length of the first side of the door. In some embodiments, the length of the sixth body portion is 50% to 85% of the length of the first side of the door. In some embodiments, the length of the sixth body portion is 50% to 80% of the length of the first side of the door. In some embodiments, the length of the sixth body portion is 50% to 75% of the length of the first side of the door. In some embodiments, the length of the sixth body portion is 50% to 70% of the length of the first side of the door. In some embodiments, the length of the sixth body portion is 50% to 65% of the length of the first side of the door. In some embodiments, the length of the sixth body portion is 50% to 60% of the length of the first side of the door. In some embodiments, the length of the sixth body portion is 50% to 55% of the length of the first side of the door.

In some embodiments, the length of the sixth body portion is 55% to 99% of the length of the first side of the door. In some embodiments, the length of the sixth body portion is 55% to 98% of the length of the first side of the door. In some embodiments, the length of the sixth body portion is 55% to 97% of the length of the first side of the door. In some embodiments, the length of the sixth body portion is 55% to 96% of the length of the first side of the door. In some embodiments, the length of the sixth body portion is 55% to 95% of the length of the first side of the door. In some embodiments, the length of the sixth body portion is 55% to 90% of the length of the first side of the door. In some embodiments, the length of the sixth body portion is 55% to 85% of the length of the first side of the door. In some embodiments, the length of the sixth body portion is 55% to 80% of the length of the first side of the door. In some embodiments, the length of the sixth body portion is 55% to 75% of the length of the first side of the door. In some embodiments, the length of the sixth body portion is 55% to 70% of the length of the first side of the door. In some embodiments, the length of the sixth body portion is 55% to 65% of the length of the first side of the door. In some embodiments, the length of the sixth body portion is 55% to 60% of the length of the first side of the door.

In some embodiments, the length of the sixth body portion is 60% to 99% of the length of the first side of the door. In some embodiments, the length of the sixth body portion is 60% to 98% of the length of the first side of the door. In some embodiments, the length of the sixth body portion is 60% to 97% of the length of the first side of the door. In some embodiments, the length of the sixth body portion is 60% to 96% of the length of the first side of the door. In some embodiments, the length of the sixth body portion is 60% to 95% of the length of the first side of the door. In some embodiments, the length of the sixth body portion is 60% to 90% of the length of the first side of the door. In some embodiments, the length of the sixth body portion is 60% to 85% of the length of the first side of the door. In some embodiments, the length of the sixth body portion is 60% to 80% of the length of the first side of the door. In some embodiments, the length of the sixth body portion is 60% to 75% of the length of the first side of the door. In some embodiments, the length of the sixth body portion is 60% to 70% of the length of the first side of the door. In some embodiments, the length of the sixth body portion is 60% to 65% of the length of the first side of the door.

In some embodiments, the length of the sixth body portion is 65% to 99% of the length of the first side of the door. In some embodiments, the length of the sixth body portion is 65% to 98% of the length of the first side of the door. In some embodiments, the length of the sixth body portion is 65% to 97% of the length of the first side of the door. In some embodiments, the length of the sixth body portion is 65% to 96% of the length of the first side of the door. In some embodiments, the length of the sixth body portion is 65% to 95% of the length of the first side of the door. In some embodiments, the length of the sixth body portion is 65% to 90% of the length of the first side of the door. In some embodiments, the length of the sixth body portion is 65% to 85% of the length of the first side of the door. In some embodiments, the length of the sixth body portion is 65% to 80% of the length of the first side of the door. In some embodiments, the length of the sixth body portion is 65% to 75% of the length of the first side of the door. In some embodiments, the length of the sixth body portion is 65% to 70% of the length of the first side of the door.

In some embodiments, the length of the sixth body portion is 70% to 99% of the length of the first side of the door. In some embodiments, the length of the sixth body portion is 70% to 98% of the length of the first side of the door. In some embodiments, the length of the sixth body portion is 70% to 97% of the length of the first side of the door. In some embodiments, the length of the sixth body portion is 70% to 96% of the length of the first side of the door. In some embodiments, the length of the sixth body portion is 70% to 95% of the length of the first side of the door. In some embodiments, the length of the sixth body portion is 70% to 90% of the length of the first side of the door. In some embodiments, the length of the sixth body portion is 70% to 85% of the length of the first side of the door. In some embodiments, the length of the sixth body portion is 70% to 80% of the length of the first side of the door. In some embodiments, the length of the sixth body portion is 70% to 75% of the length of the first side of the door.

In some embodiments, the length of the sixth body portion is 75% to 99% of the length of the first side of the door. In some embodiments, the length of the sixth body portion is 75% to 98% of the length of the first side of the door. In some embodiments, the length of the sixth body portion is 75% to 97% of the length of the first side of the door. In some embodiments, the length of the sixth body portion is 75% to 96% of the length of the first side of the door. In some embodiments, the length of the sixth body portion is 75% to 95% of the length of the first side of the door. In some embodiments, the length of the sixth body portion is 75% to 90% of the length of the first side of the door. In some embodiments, the length of the sixth body portion is 75% to 85% of the length of the first side of the door. In some embodiments, the length of the sixth body portion is 75% to 80% of the length of the first side of the door.

In some embodiments, the length of the sixth body portion is 80% to 99% of the length of the first side of the door. In some embodiments, the length of the sixth body portion is 80% to 98% of the length of the first side of the door. In some embodiments, the length of the sixth body portion is 80% to 97% of the length of the first side of the door. In some embodiments, the length of the sixth body portion is 80% to 96% of the length of the first side of the door. In some embodiments, the length of the sixth body portion is 80% to 95% of the length of the first side of the door. In some embodiments, the length of the sixth body portion is 80% to 90% of the length of the first side of the door. In some embodiments, the length of the sixth body portion is 80% to 85% of the length of the first side of the door.

In some embodiments, the length of the sixth body portion is 85% to 99% of the length of the first side of the door. In some embodiments, the length of the sixth body portion is 85% to 98% of the length of the first side of the door. In some embodiments, the length of the sixth body portion is 85% to 97% of the length of the first side of the door. In some embodiments, the length of the sixth body portion is 85% to 96% of the length of the first side of the door. In some embodiments, the length of the sixth body portion is 85% to 95% of the length of the first side of the door. In some embodiments, the length of the sixth body portion is 85% to 90% of the length of the first side of the door.

In some embodiments, the length of the sixth body portion is 90% to 99% of the length of the first side of the door. In some embodiments, the length of the sixth body portion is 90% to 98% of the length of the first side of the door. In some embodiments, the length of the sixth body portion is 90% to 97% of the length of the first side of the door. In some embodiments, the length of the sixth body portion is 90% to 96% of the length of the first side of the door. In some embodiments, the length of the sixth body portion is 90% to 95% of the length of the first side of the door.

In some embodiments, the length of the sixth body portion is 95% to 99% of the length of the first side of the door. In some embodiments, the length of the sixth body portion is 95% to 98% of the length of the first side of the door. In some embodiments, the length of the sixth body portion is 95% to 97% of the length of the first side of the door. In some embodiments, the length of the sixth body portion is 95% to 96% of the length of the first side of the door.

In some embodiments, the length of the sixth body portion is 96% to 99% of the length of the first side of the door. In some embodiments, the length of the sixth body portion is 96% to 98% of the length of the first side of the door. In some embodiments, the length of the sixth body portion is 96% to 97% of the length of the first side of the door.

In some embodiments, the length of the sixth body portion is 97% to 99% of the length of the first side of the door. In some embodiments, the length of the sixth body portion is 97% to 98% of the length of the first side of the door. In some embodiments, the length of the sixth body portion is 97% to 98% of the length of the first side of the door.

In some embodiments, a length of the first magnetic strip is at least 50% of a length of the first body portion. In some embodiments, the length of the first magnetic strip is at least 55% of the length of the first body portion. In some embodiments, the length of the first magnetic strip is at least 60% of the length of the first body portion. In some embodiments, the length of the first magnetic strip is at least 70% of the length of the first body portion. In some embodiments, the length of the first magnetic strip is at least 55% of the length of the first body portion. In some embodiments, the length of the first magnetic strip is at least 75% of the length of the first body portion. In some embodiments, the length of the first magnetic strip is at least 80% of the length of the first body portion. In some embodiments, the length of the first magnetic strip is at least 85% of the length of the first body portion. In some embodiments, the length of the first magnetic strip is at least 90% of the length of the first body portion. In some embodiments, the length of the first magnetic strip is at least 95% of the length of the first body portion. In some embodiments, the length of the first magnetic strip is at least 96% of the length of the first body portion. In some embodiments, the length of the first magnetic strip is at least 97% of the length of the first body portion. In some embodiments, the length of the first magnetic strip is at least 98% of the length of the first body portion. In some embodiments, the length of the first magnetic strip is at least 99% of the length of the first body portion.

In some embodiments, the length of the first magnetic strip is 50% to 99% of the length of the first body portion. In some embodiments, the length of the first magnetic strip is 50% to 98% of the length of the first body portion. In some embodiments, the length of the first magnetic strip is 50% to 97% of the length of the first body portion. In some embodiments, the length of the first magnetic strip is 50% to 96% of the length of the first body portion. In some embodiments, the length of the first magnetic strip is 50% to 95% of the length of the first body portion. In some embodiments, the length of the first magnetic strip is 50% to 90% of the length of the first body portion. In some embodiments, the length of the first magnetic strip is 50% to 85% of the length of the first body portion. In some embodiments, the length of the first magnetic strip is 50% to 80% of the length of the first body portion. In some embodiments, the length of the first magnetic strip is 50% to 75% of the length of the first body portion. In some embodiments, the length of the first magnetic strip is 50% to 70% of the length of the first body portion. In some embodiments, the length of the first magnetic strip is 50% to 65% of the length of the first body portion. In some embodiments, the length of the first magnetic strip is 50% to 60% of the length of the first body portion. In some embodiments, the length of the first magnetic strip is 50% to 55% of the length of the first body portion.

In some embodiments, the length of the first magnetic strip is 55% to 99% of the length of the first body portion. In some embodiments, the length of the first magnetic strip is 55% to 98% of the length of the first body portion. In some embodiments, the length of the first magnetic strip is 55% to 97% of the length of the first body portion. In some embodiments, the length of the first magnetic strip is 55% to 96% of the length of the first body portion. In some embodiments, the length of the first magnetic strip is 55% to 95% of the length of the first body portion. In some embodiments, the length of the first magnetic strip is 55% to 90% of the length of the first body portion. In some embodiments, the length of the first magnetic strip is 55% to 85% of the length of the first body portion. In some embodiments, the length of the first magnetic strip is 55% to 80% of the length of the first body portion. In some embodiments, the length of the first magnetic strip is 55% to 75% of the length of the first body portion. In some embodiments, the length of the first magnetic strip is 55% to 70% of the length of the first body portion. In some embodiments, the length of the first magnetic strip is 55% to 65% of the length of the first body portion. In some embodiments, the length of the first magnetic strip is 55% to 60% of the length of the first body portion.

In some embodiments, the length of the first magnetic strip is 60% to 99% of the length of the first body portion. In some embodiments, the length of the first magnetic strip is 60% to 98% of the length of the first body portion. In some embodiments, the length of the first magnetic strip is 60% to 97% of the length of the first body portion. In some embodiments, the length of the first magnetic strip is 60% to 96% of the length of the first body portion. In some embodiments, the length of the first magnetic strip is 60% to 95% of the length of the first body portion. In some embodiments, the length of the first magnetic strip is 60% to 90% of the length of the first body portion. In some embodiments, the length of the first magnetic strip is 60% to 85% of the length of the first body portion. In some embodiments, the length of the first magnetic strip is 60% to 80% of the length of the first body portion. In some embodiments, the length of the first magnetic strip is 60% to 75% of the length of the first body portion. In some embodiments, the length of the first magnetic strip is 60% to 70% of the length of the first body portion. In some embodiments, the length of the first magnetic strip is 60% to 65% of the length of the first body portion.

In some embodiments, the length of the first magnetic strip is 65% to 99% of the length of the first body portion. In some embodiments, the length of the first magnetic strip is 65% to 98% of the length of the first body portion. In some embodiments, the length of the first magnetic strip is 65% to 97% of the length of the first body portion. In some embodiments, the length of the first magnetic strip is 65% to 96% of the length of the first body portion. In some embodiments, the length of the first magnetic strip is 65% to 95% of the length of the first body portion. In some embodiments, the length of the first magnetic strip is 65% to 90% of the length of the first body portion. In some embodiments, the length of the first magnetic strip is 65% to 85% of the length of the first body portion. In some embodiments, the length of the first magnetic strip is 65% to 80% of the length of the first body portion. In some embodiments, the length of the first magnetic strip is 65% to 75% of the length of the first body portion. In some embodiments, the length of the first magnetic strip is 65% to 70% of the length of the first body portion.

In some embodiments, the length of the first magnetic strip is 70% to 99% of the length of the first body portion. In some embodiments, the length of the first magnetic strip is 70% to 98% of the length of the first body portion. In some embodiments, the length of the first magnetic strip is 70% to 97% of the length of the first body portion. In some embodiments, the length of the first magnetic strip is 70% to 96% of the length of the first body portion. In some embodiments, the length of the first magnetic strip is 70% to 95% of the length of the first body portion. In some embodiments, the length of the first magnetic strip is 70% to 90% of the length of the first body portion. In some embodiments, the length of the first magnetic strip is 70% to 85% of the length of the first body portion. In some embodiments, the length of the first magnetic strip is 70% to 80% of the length of the first body portion. In some embodiments, the length of the first magnetic strip is 70% to 75% of the length of the first body portion.

In some embodiments, the length of the first magnetic strip is 75% to 99% of the strip is 75% to 98% of the length of the first body portion. In some embodiments, the length of the first magnetic strip is 75% to 97% of the length of the first body portion. In some embodiments, the length of the first magnetic strip is 75% to 96% of the length of the first body portion. In some embodiments, the length of the first magnetic strip is 75% to 95% of the length of the first body portion. In some embodiments, the length of the first magnetic strip is 75% to 90% of the length of the first body portion. In some embodiments, the length of the first magnetic strip is 75% to 85% of the length of the first body portion. In some embodiments, the length of the first magnetic strip is 75% to 80% of the length of the first body portion.

In some embodiments, the length of the first magnetic strip is 80% to 99% of the length of the first body portion. In some embodiments, the length of the first magnetic strip is 80% to 98% of the length of the first body portion. In some embodiments, the length of the first magnetic strip is 80% to 97% of the length of the first body portion. In some embodiments, the length of the first magnetic strip is 80% to 96% of the length of the first body portion. In some embodiments, the length of the first magnetic strip is 80% to 95% of the length of the first body portion. In some embodiments, the length of the first magnetic strip is 80% to 90% of the length of the first body portion. In some embodiments, the length of the first magnetic strip is 80% to 85% of the length of the first body portion.

In some embodiments, the length of the first magnetic strip is 85% to 99% of the length of the first body portion. In some embodiments, the length of the first magnetic strip is 85% to 98% of the length of the first body portion. In some embodiments, the length of the first magnetic strip is 85% to 97% of the length of the first body portion. In some embodiments, the length of the first magnetic strip is 85% to 96% of the length of the first body portion. In some embodiments, the length of the first magnetic strip is 85% to 95% of the length of the first body portion. In some embodiments, the length of the first magnetic strip is 85% to 90% of the length of the first body portion. In some embodiments, the length of the first magnetic strip is 90% to 99% of the length of the first body portion. In some embodiments, the length of the first magnetic strip is 90% to 98% of the length of the first body portion. In some embodiments, the length of the first magnetic strip is 90% to 97% of the length of the first body portion. In some embodiments, the length of the first magnetic strip is 90% to 96% of the length of the first body portion. In some embodiments, the length of the first magnetic strip is 90% to 95% of the length of the first body portion.

In some embodiments, the length of the first magnetic strip is 95% to 99% of the length of the first body portion. In some embodiments, the length of the first magnetic strip is 95% to 98% of the length of the first body portion. In some embodiments, the length of the first magnetic strip is 95% to 97% of the length of the first body portion. In some embodiments, the length of the first magnetic strip is 95% to 96% of the length of the first body portion.

In some embodiments, the length of the first magnetic strip is 96% to 99% of the length of the first body portion. In some embodiments, the length of the first magnetic strip is 96% to 98% of the length of the first body portion. In some embodiments, the length of the first magnetic strip is 96% to 97% of the length of the first body portion.

In some embodiments, the length of the first magnetic strip is 97% to 99% of the length of the first body portion. In some emboidments, the length of teh first magnetic strip is 97% to 98% of the length of the first body portion. In some embodiments, the length of the first magnetic strip is 97% to 98% of the length of the first body portion.

In some embodiments, a length of the second magnetic strip is at least 50% of a length of the sixth body portion. In some embodiments, the length of the second magnetic strip is at least 55% of the length of the sixth body portion. In some embodiments, the length of the second magnetic strip is at least 60% of the length of the sixth body portion. In some embodiments, the length of the second magnetic strip is at least 70% of the length of the sixth body portion. In some embodiments, the length of the second magnetic strip is at least 55% of the length of the sixth body portion. In some embodiments, the length of the second magnetic strip is at least 75% of the length of the sixth body portion. In some embodiments, the length of the second magnetic strip is at least 80% of the length of the sixth body portion. In some embodiments, the length of the second magnetic strip is at least 85% of the length of the sixth body portion. In some embodiments, the length of the second magnetic strip is at least 90% of the length of the sixth body portion. In some embodiments, the length of the second magnetic strip is at least 95% of the length of the sixth body portion. In some embodiments, the length of the second magnetic strip is at least 96% of the length of the sixth body portion. In some embodiments, the length of the second magnetic strip is at least 97% of the length of the sixth body portion. In some embodiments, the length of the second magnetic strip is at least 98% of the length of the sixth body portion. In some embodiments, the length of the second magnetic strip is at least 99% of the length of the sixth body portion.

In some embodiments, the length of the second magnetic strip is 50% to 99% of the length of the sixth body portion. In some embodiments, the length of the second magnetic strip is 50% to 98% of the length of the sixth body portion. In some embodiments, the length of the second magnetic strip is 50% to 97% of the length of the sixth body portion. In some embodiments, the length of the second magnetic strip is 50% to 96% of the length of the sixth body portion. In some embodiments, the length of the second magnetic strip is 50% to 95% of the length of the sixth body portion. In some embodiments, the length of the second magnetic strip is 50% to 90% of the length of the sixth body portion. In some embodiments, the length of the second magnetic strip is 50% to 85% of the length of the sixth body portion. In some embodiments, the length of the second magnetic strip is 50% to 80% of the length of the sixth body portion. In some embodiments, the length of the second magnetic strip is 50% to 75% of the length of the sixth body portion. In some embodiments, the length of the second magnetic strip is 50% to 70% of the length of the sixth body portion. In some embodiments, the length of the second magnetic strip is 50% to 65% of the length of the sixth body portion. In some embodiments, the length of the second magnetic strip is 50% to 60% of the length of the sixth body portion. In some embodiments, the length of the second magnetic strip is 50% to 55% of the length of the sixth body portion. In some embodiments, the length of the second magnetic strip is 55% to 99% of the length of the sixth body portion. In some embodiments, the length of the second magnetic strip is 55% to 98% of the length of the sixth body portion. In some embodiments, the length of the second magnetic strip is 55% to 97% of the length of the sixth body portion. In some embodiments, the length of the second magnetic strip is 55% to 96% of the length of the sixth body portion. In some embodiments, the length of the second magnetic strip is 55% to 95% of the length of the sixth body portion. In some embodiments, the length of the second magnetic strip is 55% to 90% of the length of the sixth body portion. In some embodiments, the length of the second magnetic strip is 55% to 85% of the length of the sixth body portion. In some embodiments, the length of the second magnetic strip is 55% to 80% of the length of the sixth body portion. In some embodiments, the length of the second magnetic strip is 55% to 75% of the length of the sixth body portion. In some embodiments, the length of the second magnetic strip is 55% to 70% of the length of the sixth body portion. In some embodiments, the length of the second magnetic strip is 55% to 65% of the length of the sixth body portion. In some embodiments, the length of the second magnetic strip is 55% to 60% of the length of the sixth body portion.

In some embodiments, the length of the second magnetic strip is 60% to 99% of the length of the sixth body portion. In some embodiments, the length of the second magnetic strip is 60% to 98% of the length of the sixth body portion. In some embodiments, the length of the second magnetic strip is 60% to 97% of the length of the sixth body portion. In some embodiments, the length of the second magnetic strip is 60% to 96% of the length of the sixth body portion. In some embodiments, the length of the second magnetic strip is 60% to 95% of the length of the sixth body portion. In some embodiments, the length of the second magnetic strip is 60% to 90% of the length of the sixth body portion. In some embodiments, the length of the second magnetic strip is 60% to 85% of the length of the sixth body portion. In some embodiments, the length of the second magnetic strip is 60% to 80% of the length of the sixth body portion. In some embodiments, the length of the second magnetic strip is 60% to 75% of the length of the sixth body portion. In some embodiments, the length of the second magnetic strip is 60% to 70% of the length of the sixth body portion. In some embodiments, the length of the second magnetic strip is 60% to 65% of the length of the sixth body portion.

In some embodiments, the length of the second magnetic strip is 65% to 99% of the length of the sixth body portion. In some embodiments, the length of the second magnetic strip is 65% to 98% of the length of the sixth body portion. In some embodiments, the length of the second magnetic strip is 65% to 97% of the length of the sixth body portion. In some embodiments, the length of the second magnetic strip is 65% to 96% of the length of the sixth body portion. In some embodiments, the length of the second magnetic strip is 65% to 95% of the length of the sixth body portion. In some embodiments, the length of the second magnetic strip is 65% to 90% of the length of the sixth body portion. In some embodiments, the length of the second magnetic strip is 65% to 85% of the length of the sixth body portion. In some embodiments, the length of the second magnetic strip is 65% to 80% of the length of the sixth body portion. In some embodiments, the length of the second magnetic strip is 65% to 75% of the length of the sixth body portion. In some embodiments, the length of the second magnetic strip is 65% to 70% of the length of the sixth body portion.

In some embodiments, the length of the second magnetic strip is 70% to 99% of the length of the sixth body portion. In some embodiments, the length of the second magnetic strip is 70% to 98% of the length of the sixth body portion. In some embodiments, the length of the second magnetic strip is 70% to 97% of the length of the sixth body portion. In some embodiments, the length of the second magnetic strip is 70% to 96% of the length of the sixth body portion. In some embodiments, the length of the second magnetic strip is 70% to 95% of the length of the sixth body portion. In some embodiments, the length of the second magnetic strip is 70% to 90% of the length of the sixth body portion. In some embodiments, the length of the second magnetic strip is 70% to 85% of the length of the sixth body portion. In some embodiments, the length of the second magnetic strip is 70% to 80% of the length of the sixth body portion. In some embodiments, the length of the second magnetic strip is 70% to 75% of the length of the sixth body portion.

In some embodiments, the length of the second magnetic strip is 75% to 99% of the length of the sixth body portion. In some embodiments, the length of the second magnetic strip is 75% to 98% of the length of the sixth body portion. In some embodiments, the length of the second magnetic strip is 75% to 97% of the length of the sixth body portion. In some embodiments, the length of the second magnetic strip is 75% to 96% of the length of the sixth body portion. In some embodiments, the length of the second magnetic strip is 75% to 95% of the length of the sixth body portion. In some embodiments, the length of the second magnetic strip is 75% to 90% of the length of the sixth body portion. In some embodiments, the length of the second magnetic strip is 75% to 85% of the length of the sixth body portion. In some embodiments, the length of the second magnetic strip is 75% to 80% of the length of the sixth body portion.

In some embodiments, the length of the second magnetic strip is 80% to 99% of the length of the sixth body portion. In some embodiments, the length of the second magnetic strip is 80% to 98% of the length of the sixth body portion. In some embodiments, the length of the second magnetic strip is 80% to 97% of the length of the sixth body portion. In some embodiments, the length of the second magnetic strip is 80% to 96% of the length of the sixth body portion. In some embodiments, the length of the second magnetic strip is 80% to 95% of the length of the sixth body portion. In some embodiments, the length of the second magnetic strip is 80% to 90% of the length of the sixth body portion. In some embodiments, the length of the second magnetic strip is 80% to 85% of the length of the sixth body portion.

In some embodiments, the length of the second magnetic strip is 85% to 99% of the length of the sixth body portion. In some embodiments, the length of the second magnetic strip is 85% to 98% of the length of the sixth body portion. In some embodiments, the length of the second magnetic strip is 85% to 97% of the length of the sixth body portion. In some embodiments, the length of the second magnetic strip is 85% to 96% of the length of the sixth body portion. In some embodiments, the length of the second magnetic strip is 85% to 95% of the length of the sixth body portion. In some embodiments, the length of the second magnetic strip is 85% to 90% of the length of the sixth body portion.

In some embodiments, the length of the second magnetic strip is 90% to 99% of the length of the sixth body portion. In some embodiments, the length of the second magnetic strip is 90% to 98% of the length of the sixth body portion. In some embodiments, the length of the second magnetic strip is 90% to 97% of the length of the sixth body portion. In some embodiments, the length of the second magnetic strip is 90% to 96% of the length of the sixth body portion. In some embodiments, the length of the second magnetic strip is 90% to 95% of the length of the sixth body portion.

In some embodiments, the length of the second magnetic strip is 95% to 99% of the length of the sixth body portion. In some embodiments, the length of the second magnetic strip is 95% to 98% of the length of the sixth body portion. In some embodiments, the length of the second magnetic strip is 95% to 97% of the length of the sixth body portion. In some embodiments, the length of the second magnetic strip is 95% to 96% of the length of the sixth body portion.

In some embodiments, the length of the second magnetic strip is 96% to 99% of the length of the sixth body portion. In some embodiments, the length of the second magnetic strip is 96% to 98% of the length of the sixth body portion. In some embodiments, the length of the second magnetic strip is 96% to 97% of the length of the sixth body portion.

In some embodiments, the length of the second magnetic strip is 97% to 99% of the length of the sixth body portion. In some embodiments, the length of the second magnetic strip is 97% to 98% of the length of the sixth body portion. In some embodiments, the length of the second magnetic strip is 97% to 98% of the length of the sixth body portion.

In some embodiments, an adhesive adheres the first magnetic strip to the first body portion. In some embodiments, an adhesive adheres the second magnetic strip to the sixth body portion. In some embodiments, one or both of the adhesives comprise an acrylic adhesive. In some embodiments, one or both of the adhesives comprise a pressure sensitive adhesive. In some embodiments, one or both of the adhesives comprise a pressure sensitive acrylic adhesive.

In some embodiments, the first magnetic strips comprises more than one magnetic strip on the first body portion. In some embodiments, there are two magnetic strips on the first body portion. In some embodiments, there are three magnetic strips on the first body portion. In some embodiments, there are four magnetic strips on the first body portion. In some embodiments, there are five magnetic strips on the first body portion. In some embodiments, there are six magnetic strips on the first body portion. In some embodiments, there are seven magnetic strips on the first body portion. In some embodiments, there are eight magnetic strips on the first body portion. In some embodiments, there are nine magnetic strips on the first body portion. In some embodiments, there are ten magnetic strips on the first body portion. In some embodiments, there are more than ten magnetic strips on the first body portion. In some embodiments, two or more of the magnetic strips are spaced apart. In some embodiments, two or more of the magnetic strips abut one another.

In some embodiments, the second magnetic strip comprises more than one magnetic strip on the sixth body portion. In some embodiments, there are two magnetic strips on the sixth body portion. In some embodiments, there are three magnetic strips on the sixth body portion. In some embodiments, there are four magnetic strips on the sixth body portion. In some embodiments, there are five magnetic strips on the sixth body portion. In some embodiments, there are six magnetic strips on the sixth body portion. In some embodiments, there are seven magnetic strips on the sixth body portion. In some embodiments, there are eight magnetic strips on the sixth body portion. In some embodiments, there are nine magnetic strips on the sixth body portion. In some embodiments, there are ten magnetic strips on the sixth body portion. In some embodiments, there are more than ten magnetic strips on the sixth body portion. In some embodiments, two or more of the magnetic strips are spaced apart. In some embodiments, two or more of the magnetic strips abut one another.

In some embodiments, an overall length of the guard is approximately 60 inches. In some embodiments, the overall length of the guard is less than approximately 60 inches. In some embodiments, the overall length of the guard is more than approximately 60 inches.

In some embodiments, the overall length of the guard is approximately 30 inches. In some embodiments, the overall length of the guard is approximately 35 inches. In some embodiments, the overall length of the guard is approximately 40 inches. In some embodiments, the overall length of the guard is approximately 45 inches. In some embodiments, the overall length of the guard is approximately 50 inches. In some embodiments, the overall length of the guard is approximately 55 inches. In some embodiments, the overall length of the guard is approximately 60 inches. In some embodiments, the overall length of the guard is approximately 65 inches. In some embodiments, the overall length of the guard is approximately 70 inches.

In some embodiments, the overall length of the guard is approximately 30 inches to 70 inches. In some embodiments, the overall length of the guard is approximately 35 inches to 70 inches. In some embodiments, the overall length of the guard is approximately 40 inches to 70 inches. In some embodiments, the overall length of the guard is approximately 45 inches to 70 inches. In some embodiments, the overall length of the guard is approximately 50 inches to 70 inches. In some embodiments, the overall length of the guard is approximately 55 inches to 70 inches. In some embodiments, the overall length of the guard is approximately 60 inches to 70 inches. In some embodiments, the overall length of the guard is approximately 65 inches to 70 inches.

In some embodiments, the overall length of the guard is approximately 30 inches to 65 inches. In some embodiments, the overall length of the guard is approximately 35 inches to 65 inches. In some embodiments, the overall length of the guard is approximately 40 inches to 65 inches. In some embodiments, the overall length of the guard is approximately 45 inches to 65 inches. In some embodiments, the overall length of the guard is approximately 50 inches to 65 inches. In some embodiments, the overall length of the guard is approximately 55 inches to 65 inches. In some embodiments, the overall length of the guard is approximately 60 inches to 65 inches.

In some embodiments, the overall length of the guard is approximately 30 inches to 60 inches. In some embodiments, the overall length of the guard is approximately 35 inches to 60 inches. In some embodiments, the overall length of the guard is approximately 40 inches to 60 inches. In some embodiments, the overall length of the guard is approximately 45 inches to 60 inches. In some embodiments, the overall length of the guard is approximately 50 inches to 60 inches. In some embodiments, the overall length of the guard is approximately 55 inches to 60 inches.

In some embodiments, the overall length of the guard is approximately 30 inches to 55 inches. In some embodiments, the overall length of the guard is approximately 35 inches to 55 inches. In some embodiments, the overall length of the guard is approximately 40 inches to 55 inches. In some embodiments, the overall length of the guard is approximately 45 inches to 55 inches. In some embodiments, the overall length of the guard is approximately 50 inches to 55 inches.

In some embodiments, the overall length of the guard is approximately 30 inches to 50 inches. In some embodiments, the overall length of the guard is approximately 35 inches to 50 inches. In some embodiments, the overall length of the guard is approximately 40 inches to 50 inches. In some embodiments, the overall length of the guard is approximately 45 inches to 50 inches.

In some embodiments, the overall length of the guard is approximately 30 inches to 45 inches. In some embodiments, the overall length of the guard is approximately 35 inches to 45 inches. In some embodiments, the overall length of the guard is approximately 40 inches to 45 inches.

In some embodiments, the overall length of the guard is approximately 30 inches to 40 inches. In some embodiments, the overall length of the guard is approximately 35 inches to 40 inches. In some embodiments, the overall length of the guard is approximately 30 inches to 35 inches.

In some embodiments, when the guard is installed on a doorframe, the guard is about 1 inch from a floor surface. In some embodiments, when the guard is installed on the doorframe, the guard is more than about 1 inch from a floor surface. In some embodiments, when the guard is installed on the doorframe, the guard is less than about 1 inch from a floor surface. In some embodiments, when the guard is installed on the doorframe, the guard about 2 inches from a floor surface. In some embodiments, when the guard is installed on the doorframe, the guard about 3 inches from a floor surface. In some embodiments, when the guard is installed on the doorframe, the guard about 4 inches from a floor surface. In some embodiments, when the guard is installed on the doorframe, the guard about 5 inches from a floor surface. In some embodiments, when the guard is installed on the doorframe, the guard about 6 inches from a floor surface. In some embodiments, when the guard is installed on the doorframe, the guard about 7 inches from a floor surface. In some embodiments, when the guard is installed on the doorframe, the guard about 8 inches from a floor surface. In some embodiments, when the guard is installed on the doorframe, the guard about 9 inches from a floor surface. In some embodiments, when the guard is installed on the doorframe, the guard about 10 inches from a floor surface. In some embodiments, when the guard is installed on the doorframe, the guard about 11 inches from a floor surface. In some embodiments, when the guard is installed on the doorframe, the guard about 12 inches from a floor surface. In some embodiments, when the guard is installed on the doorframe, the guard more than about 12 inches from a floor surface.

In some embodiments, the guard is manufactured by a molding process. In some embodiments, the guard is manufactured by an extrusion process. In some embodiments, the magnetic strips are installed on the first and sixth body portions simultaneously with the molding process. In some embodiments, the magnetic strips are installed on the first and sixth body portions after the molding process. In some embodiments, the magnetic strips are installed on the first and sixth body portions during extrusion. In some embodiments, the magnetic strips are installed on the first and sixth body portions after extrusion.

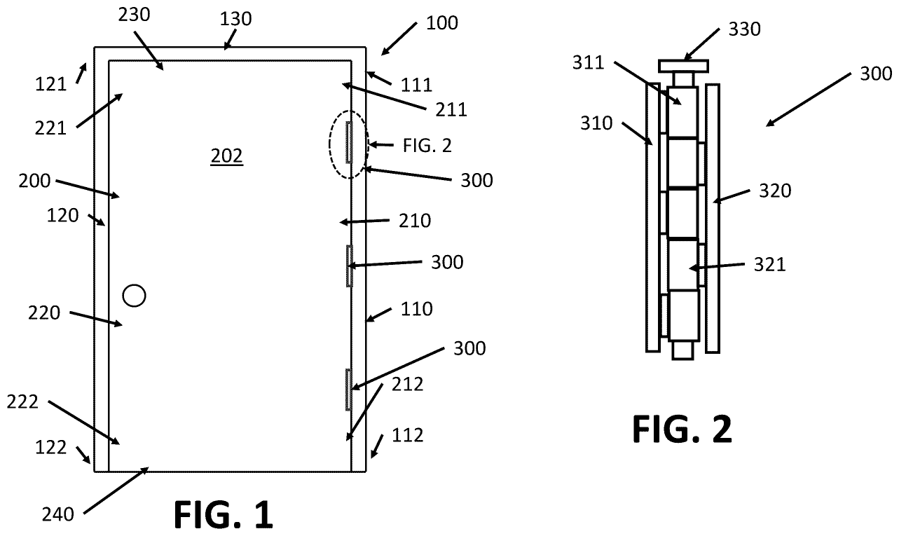

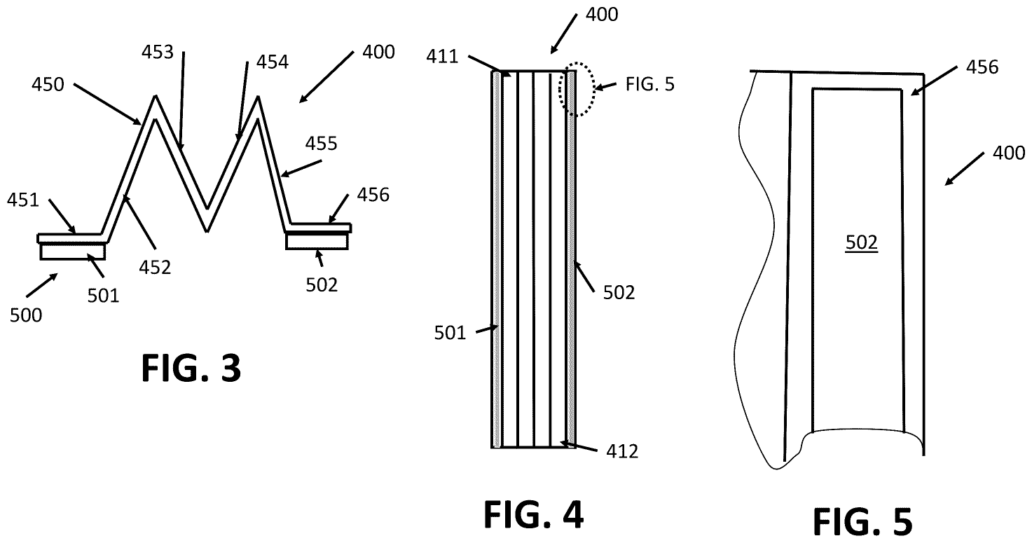

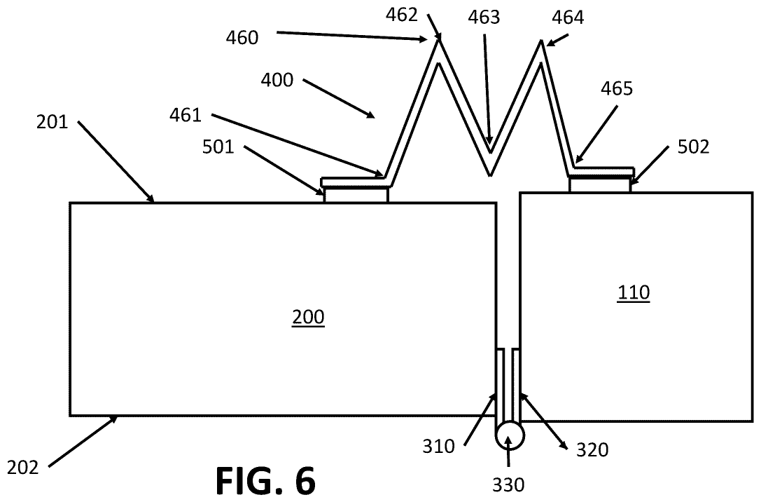

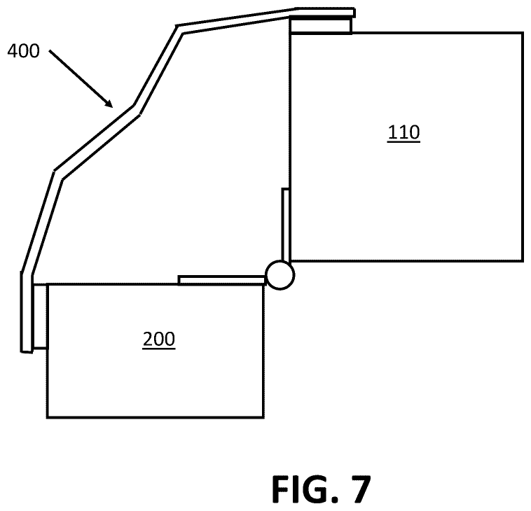

With reference to the figures, FIG. 1 shows a front view of a doorframe framing a door, and onto which the guard may be installed; FIG. 2 shows a detail view of a door hinge from FIG. 1, which connects the door to the doorframe; FIG. 3 shows a schematic top view of the guard; FIG. 4 shows a front view of the guard of FIG. 3; FIG. 5 shows a detail view, from FIG. 4, of the guard; FIG. 6 shows a top view of the guard installed on the doorframe and the door when the door is closed; and FIG. 7 shows a top view of the guard installed on the doorframe and the door when the door is open, in accordance with some embodiments of the invention. As shown in the figures, in some embodiments, the system includes a doorframe 100, which includes a first side jamb 110 having a top end 111 and a bottom end 112, a second side jamb 120 having a top end 121 and a bottom end 122, and a head jamb 130 extending between i) the top end 111 of the first side jamb 110 and ii) the top end 121 of the second side jamb 120. In some embodiments, the first side jamb 110 comprises a magnetic material. Any or all of the doorframe 100, the first side jamb 110, and/or the second side jamb 120, may be as described above. The first side jamb 110 and the second side jamb 120 may be on opposite sides of the doorframe 100 than those the figures show.

As the figures show, in some embodiments, the system includes a door 200. In some embodiments, the door 200 may be as described above. As shown, in some embodiments, the door 200 has a first side 210 with a top end 211 and a bottom end 212; a second side 220 with a top end 221 and a bottom end 222; a top side 230 extending between i) the top end 211 of the first side 210 and ii) the top end 221 of the second side 220; and a bottom side 240 extending between i) the bottom end 212 of the first side 210 and ii) the bottom end 222 of the second side 220. In some embodiments, at least some portion of the door 200 comprises a magnetic material, as described, for installation of the guard. The first side 210 and the second side 220 may be on opposite sides of the door 200 than those the figures show.

The figures show a plurality of door hinges 300 that connect the doorframe 100 to the door 200, according to some embodiment. In some embodiments, any or all of the door hinges 300 may be as described above. Further, as discussed, the system may include one, two, three, four, five, six, or more than six door hinges 300. Further, the one or more door hinges may be on either side of the doorframe 100.

With reference to FIGS. 3-7, the system includes a guard 400. In some embodiments, the guard 400 may be as described above. Thus, in some embodiments, the guard 400 may cover a gap between the door 200 and the doorframe 100.

As shown, in some embodiments, the guard 400 comprises a plurality of body portions 450, wherein each of the body portions 450 comprises a top end 411 and a bottom end 412. In some embodiments, the plurality of body portions comprises a first body portion 451, a second body portion 452, a third body portion 453, a fourth body portion 454, a fifth body portion 455, and a sixth body portion 456. As shown, the first body portion 451 connects to the second body portion 452, the second body portion 452 connects to the third body portion 453, the third body portion 453 connects to the fourth body portion 454, the fourth body portion 454 connects to the fifth body portion 455, and the fifth body portion 455 connects to the sixth body portion 456. The body portions 450 of the guard 400 may be on opposite sides of the guard 400 than those shown in the figures.

In some embodiments, the system comprises a plurality of magnetic strips 500. In some embodiments, one or more, or all, of the magnetic strips 500 may be as described above. As shown, in some embodiments, the plurality of magnetic strips 500 includes a first magnetic strip 501 adhered to the first body portion 451, and a second magnetic strip 502 adhered to the sixth body portion 456. As shown in FIG. 6, in some embodiments, when installed, the first magnetic strip 501 is magnetically coupled to the door 200, and the second magnetic strip 502 is magnetically coupled to the first side jamb 110.

As the figures show (see, e.g., FIG. 6), and as described above, in some embodiments, the guard 400 may include a plurality of connecting portions 460, which hingedly connect the body portions 450 to one another. In some embodiments, the plurality of connecting portions 460 includes a first connecting portion 461, a second connecting portion 462, a third connecting portion 463, a fourth connecting portion 464, and a fifth connecting portion 465. As shown, in some embodiments, the first connecting portion 461 connects the first body portion 451 and the second body portion 452, the second connecting portion 462 connects the second body portion 452 and the third body portion 453, the third connecting portion 463 connects the third body portion 453 and the fourth body portion 454, the fourth connecting portion 464 connects the fourth body portion 454 and the fifth body portion 455, and the fifth connecting portion 465 connects the fifth body portion 455 and the sixth body portion 456.

FIGS. 1, 2, 6, and 7 show details of one of the door hinges 300, in accordance with some embodiments of the invention. As shown, in some embodiments, the door hinge 300 comprises a first hinge leaf 310 and a second hinge leaf 320, connected to the door 200 and the doorframe 100. In some embodiments, at least a first hinge knuckle 311 connects to the first hinge leaf 310, and at least a second hinge knuckle 321 connects to the second hinge leaf 320, while a hinge pin 330 connects the first hinge knuckle 311 and the second hinge knuckle 321. However, in some embodiments, the first hinge leaf 310 includes more than one first hinge knuckle 311, and/or the second hinge leaf 320 includes more than one second hinge knuckle 321.

FIGS. 6 and 7 show examples of the shape of the guard 400 when the door 200 is opened and closed, according to some embodiments of the invention. In some embodiments, as shown in the figures, the guard 400 connects to a first face 201 of the door 200, such that the guard 400 does not cover the first hinge knuckle 311, the second hinge knuckle 321, and the hinge pin 330. In some embodiments, the guard 400 connects to a second face 202 of the door 200, such that the guard 400 covers the first hinge knuckle 311, the second hinge knuckle 321, and the hinge pin 330. In some embodiments, the system includes multiple guards 400, such as, for example, on guard 400 on each side of the door 200.

Variations, modifications, and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A system, comprising:
a doorframe, comprising:
a first side jamb, having a top end and a bottom end,
a second side jamb, having a top end and a bottom end, and
a head jamb, extending between the top end of the first side jamb and the top end of the second side jamb,
wherein the first side jamb comprises a magnetic material;
a door, comprising:
a first side, having a top end and a bottom end,
a second side, having a top end and a bottom end,
a bottom side, extending between the bottom end of the first side of the door and the bottom end of the second side of the door, and
a top side, extending between the top end of the first side of the door and the top end of the second side of the door,
wherein the door comprises a magnetic material;
a door hinge that connects the first side jamb of the doorframe to the first side of the door;
a guard, comprising:
a plurality of body portions,
wherein each of the body portions comprises a top end and a bottom end,
wherein the plurality of body portions comprises a first body portion, a second body portion, a third body portion, a fourth body portion, a fifth body portion, and a sixth body portion,
wherein the first body portion connects to the second body portion,
wherein the second body portion connects to the third body portion,
wherein the third body portion connects to the fourth body portion,
wherein the fourth body portion connects to the fifth body portion,
wherein the fifth body portion connects to the sixth body portion,
wherein the second body portion, the third body portion, the fourth body portion, and the fifth body portion form an M shape when the door is in a closed position, and
wherein the second body portion, the third body portion, the fourth body portion, and the fifth body portion are extended when the door is in an open position; and
a plurality of magnetic strips,
wherein the plurality of magnetic strips comprises a first magnetic strip and a second magnetic strip,
wherein the first magnetic strip and the second magnetic strip are magnets,
wherein the first magnetic strip is adhered to the first body portion and extends between the top end of the first body portion and the bottom end of the first body portion,
wherein the second magnetic strip is adhered to the sixth body portion and extends between the top end of the sixth body portion and the bottom end of the sixth body portion,
wherein the first magnetic strip is magnetically coupled to the door, and
wherein the second magnetic strip is magnetically coupled to the first side jamb.

2. The system of claim 1, wherein the guard further comprises:
a plurality of connecting portions,
wherein the plurality of connecting portions comprises a first connecting portion, a second connecting portion, a third connecting portion, a fourth connecting portion, and a fifth connecting portion,
wherein the first connecting portion connects the first body portion and the second body portion,
wherein the second connecting portion connects the second body portion and the third body portion,
wherein the third connecting portion connects the third body portion and the fourth body portion,
wherein the fourth connecting portion connects the fourth body portion and the fifth body portion, and
wherein the fifth connecting portion connects the fifth body portion and the sixth body portion.

3. The system of claim 1, wherein the guard comprises polymer.

4. (canceled)

5. (canceled)

6. (canceled)

7. The system of claim 2, wherein the second connecting portion hingedly connects the second body portion and the third body portion,
wherein the third connecting portion hingedly connects the third body portion and the fourth body portion, and
wherein the fourth connecting portion hingedly connects the fourth body portion and the fifth body portion.

8. The system of claim 1, wherein the door hinge comprises a first hinge leaf, a second hinge leaf, a first hinge knuckle connected to the first hinge leaf, a second hinge knuckle connected to the second hinge leaf, and a hinge pin connecting the first hinge knuckle and the second hinge knuckle,
wherein the door comprises a first face and a second face opposite the first face,
wherein the first hinge knuckle is proximate the first face of the door, and
wherein the first magnetic strip is magnetically coupled to the first face of the door, such that the guard covers the first hinge knuckle.

9. The system of claim 1, wherein the door hinge comprises a first hinge leaf, a second hinge leaf, a first hinge knuckle connected to the first hinge leaf, a second hinge knuckle connected to the second hinge leaf, and a hinge pin connecting the first hinge knuckle and the second hinge knuckle,
wherein the door comprises a first face and a second face opposite the first face,
wherein the first hinge knuckle is proximate the second face of the door, and
wherein the first magnetic strip is magnetically coupled to the first face of the door.

10. The system of claim 1, wherein a length of the first body portion is at least 50% of a length of the first side of the door.

11. The system of claim 1, wherein a length of the first magnetic strip is at least 50% of a length of the first body portion.

12. A guard, comprising:
a door,
a plurality of body portions,
wherein each of the body portions comprises a top end and a bottom end,
wherein the plurality of body portions comprises a first body portion, a second body portion, a third body portion, a fourth body portion, a fifth body portion, and a sixth body portion,
wherein the first body portion connects to the second body portion,
wherein the second body portion connects to the third body portion,
wherein the third body portion connects to the fourth body portion,
wherein the fourth body portion connects to the fifth body portion,
wherein the fifth body portion connects to the sixth body portion,
wherein the second body portion, the third body portion, the fourth body portion, and the fifth body portion form an M shape when the door is in a closed position, and
wherein the second body portion, the third body portion, the fourth body portion, and the fifth body portion are extended when the door is in an open position; and
a plurality of magnetic strips,
wherein the plurality of magnetic strips comprises a first magnetic strip and a second magnetic strip,
wherein the first magnetic strip and the second magnetic strip are magnets,
wherein the first magnetic strip is adhered to the first body portion and between the top end of the first body portion and the bottom end of the first body portion,
wherein the second magnetic strip is adhered to the sixth body portion and between the top end of the sixth body portion and the bottom end of the sixth body portion,
wherein the first magnetic strip is configured to magnetically couple to the door, wherein the door is framed by a doorframe, and
wherein the second magnetic strip is configured to magnetically couple to the doorframe.

13. The guard of claim 12, further comprising:
a plurality of connecting portions,
wherein the plurality of connecting portions comprises a first connecting portion, a second connecting portion, a third connecting portion, a fourth connecting portion, and a fifth connecting portion,
wherein the first connecting portion connects the first body portion and the second body portion,
wherein the second connecting portion connects the second body portion and the third body portion,
wherein the third connecting portion connects the third body portion and the fourth body portion,
wherein the fourth connecting portion connects the fourth body portion and the fifth body portion, and
wherein the fifth connecting portion connects the fifth body portion and the sixth body portion.

14. The guard of claim 12, wherein plurality of connecting portions comprises polymer.

15. The guard of claim 12, wherein the first magnetic strip extends from the top end of the first body portion to the bottom end of the first body portion.

16. The guard of claim 15, wherein the second magnetic strip extends from the top end of the sixth body portion to the bottom end of the sixth body portion.

17. The guard of claim 12, wherein a length of the first magnetic strip is at least 50% of a length of the first body portion.

18. The guard of claim 13, wherein the second connecting portion hingedly connects the second body portion and the third body portion,
wherein the third connecting portion hingedly connects the third body portion and the fourth body portion, and
wherein the fourth connecting portion hingedly connects the fourth body portion and the fifth body portion.

19. The guard of claim 12, further comprising:
a first adhesive that adheres the first magnetic strip to the first body portion, and
a second adhesive that adheres the second magnetic strip to the sixth body portion.

20. The guard of claim 12, wherein a length of the first magnetic strip is at least 50% of a length of the first body portion.
